(19) United States
(12) Patent Application Publication
(10) Pub. No.: US 2007/0256349 A1
(43) Pub. Date: Nov. 8, 2007

(54) Apparatus for holding a fishhook and method of use

(76) Inventor: Douglas Fyvolent, St. Petersburg, FL (US)

Correspondence Address: LARSON AND LARSON, 11199 69TH STREET NORTH, LARGO, FL, 33773, US

(21) Appl. No.: 11/417,779

(22) Filed: May 4, 2006

(51) Int. Cl. A01K 97/06; A01K 97/00

(52) U.S. Cl. 43/57.1; 43/4; 43/53.5

(57) ABSTRACT

A fishhook holder has a first engagement arm having a first jaw and a first handle end; and a second engagement arm having a second jaw and a second handle end. A pivot couples the first engagement arm with the second engagement arm and a spring interposed between the first handle end and the second handle end exerts outward force between the handle ends, thereby exerting a closing force between the first jaw and the second jaw. A groove is set in an engagement surface of at least one of the first jaw and the second jaw for holding a fishhook in place and a hook receiving hole is within the first engagement arm and is positioned substantially centered widthwise between the first jaw and the pivot means. A guard is attached to the first engagement arm, at least partially covering the hook receiving hole. The guard covers a barb end of the fishhook when the fishhook is held between the first jaw and the second jaw and the barb passes through the hook receiving hole, thereby helping to protect the holder from being pierced by the barb.

### BACKGROUND OF THE INVENTION

1. Field of the Invention

This invention relates to the field of fishing and more particularly to a device for holding a fishhook while tying a leader line onto the fishhook.

2. Description of the Related Art

Fishing hooks come in various shapes and sizes, some with a pre-attached leader and some, just the bare hook with an eye at one end for attaching a fishing line. Fishing line is often made of nylon, a very slippery material that easily slips out of most simple knots. Therefore, a complex knot is required and it is difficult to tie such a knot while holding the sharp end of a fishing hook. A simple slip results in being stuck with a fishing hook that is very difficult to remove due to the sharp barb.

What is needed is fishhook holder that will hold a fishhook so that a person can tie a fishing line on the eye of the fishhook while the fishhook holder helps protect the person from getting stuck with the barb end of the fishhook.

### SUMMARY OF THE INVENTION

One objective of the present invention is to provide a device to hold a fishing hook while tying a fishing line to the fishing hook.

Another objective of the present invention is to provide a guard that covers the point or barb of the fishing hook while holding the fishing hook, thereby reducing the probability of getting pierced by the sharp point or barb of the fishing hook.

In one embodiment, a fishhook holder is disclosed including a first engagement jaw and a second engagement jaw for engaging a fishhook there between. A first engagement arm is pivotally interfaced with a second engagement arm by a pivot, wherein the first engagement jaw is at the front end of the first engagement arm and the second engagement jaw is at the front of the second engagement arm and the first engagement arm extends beyond the pivot, thereby forming a first handle and the second engagement arm extends beyond the pivot, thereby forming a second handle. A spring is operatively coupled between and applies outward force against the first and second handle, thereby applying a closing force between the first engagement jaw and the second engagement jaw. A hole in the first engagement arm between the first engagement jaw and the pivot accepts the barb of the fishhook.

In another embodiment, a method of tying a fishing line to a fishhook is disclosed including providing a fishhook holder. The fishhook holder has a first engagement jaw and a second engagement jaw for engaging a fishhook there between. It also has a first engagement arm pivotally interfaced with a second engagement arm by a pivot, whereas the first engagement jaw is at a front end of the first engagement arm and the second engagement jaw is at the front of the second engagement arm. The back end of the first engagement arm extends beyond the pivot, thereby forming a first handle and the back end of the second engagement arm extends beyond the pivot, thereby forming a second handle. A spring is operatively coupled between and applies outward force against the first and second handle, thereby applying a closing force between the first engagement jaw and the second engagement jaw. A hole in the first engagement arm between the first engagement jaw and the pivot accepts the barb end of the fishhook and a groove in an interfacing surface of the second engagement jaw accepting the fishhook. The method continues with squeezing the first and second handle, thereby opening the first engagement jaw and the second engagement jaw then inserting the barb end of the fishhook between the first engagement jaw and the second engagement jaw, passing through the hole in the first engagement arm and resting within the groove. Now, releasing the first and second handle thereby holds the fishing hook tightly between the first engagement jaw and the second engagement jaw while the fishing line is tied to an eyelet of the fishing hook. When done tying the knot, squeezing the first and second handle a second time opens the first engagement jaw and the second engagement jaw and the fishhook is removed from the fishhook holder.

In another embodiment, a fishhook holder is disclosed with a first engagement arm having a first jaw and a first handle end; and a second engagement arm having a second jaw and a second handle end. A pivot couples the first engagement arm with the second engagement arm and a spring interposed between the first handle end and the second handle end exerts outward force between the handle ends, thereby exerting a closing force between the first jaw and the second jaw. A groove is set in an engagement surface of at least one of the first jaw and the second jaw for holding a fishhook in place and a hook receiving hole is within the first engagement arm and is positioned substantially centered widthwise between the first jaw and the pivot means. A guard is attached to the first engagement arm, at least partially covering the hook receiving hole. The guard covers a barb end of the fishhook when the fishhook is held between the first jaw and the second jaw and the barb passes through the hook receiving hole.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view of a fishhook holder of the present invention including a fishing hook.

FIG. 2 illustrates a plan view of a fishhook holder of the present invention without fishing hook.

FIG. 3 illustrates a rear view of the fishhook holder of the present invention.

FIG. 4 illustrates a front perspective view of the fishhook holder of the present invention.

FIG. 5 illustrates a front perspective view of the fishhook holder of the present invention.

FIG. 6 illustrates a front perspective view of a second embodiment of the fishhook holder of the present invention.

FIG. 7 illustrates a front perspective view of the fishhook holder of the present invention as it is being used.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

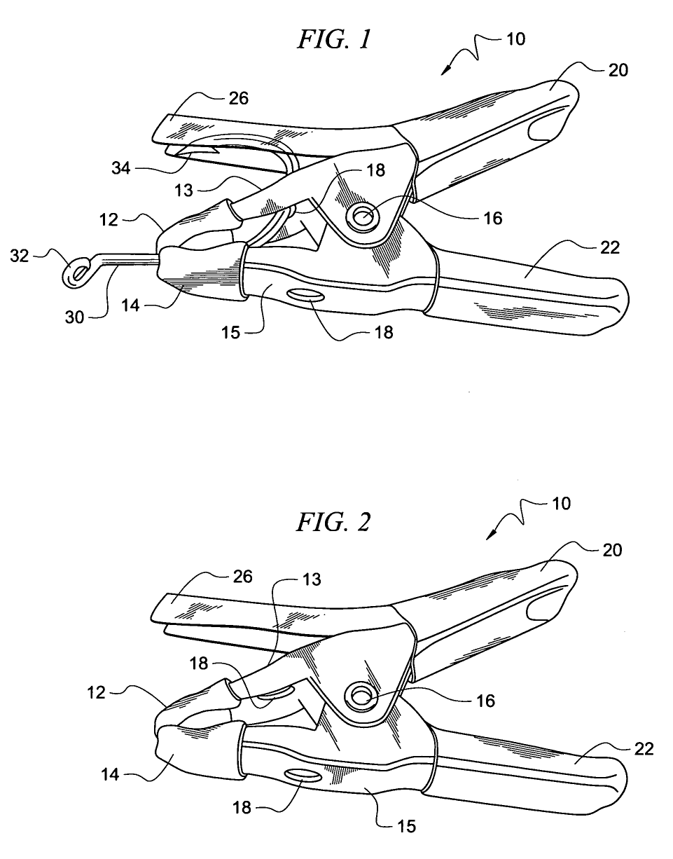

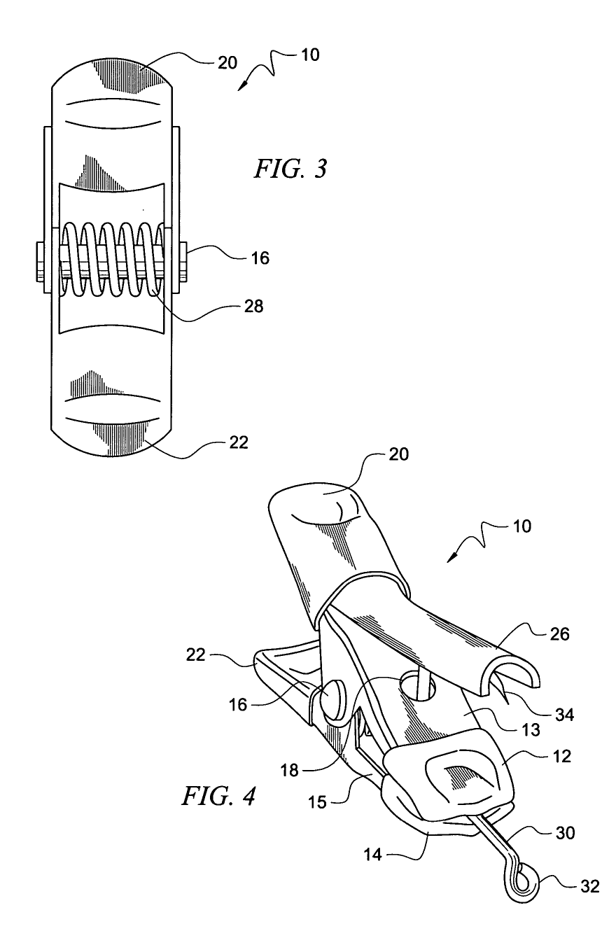

Referring to FIG. 1, a plan view of a fishhook holder 10 of the present invention including a fishing hook is shown. The fishhook holder 10 is a spring-tensioned clamp having jaw tips 12/14 for grasping the fishhook 30. In one embodiment, the jaw tips 12/14 are a continuous part of the engagement arms 13/15. In another embodiment, the jaw tips 12/14 are formed separately of a different material than that of the engagement arms 13/15. For example, the engagement arms can be made of copper or steel while the jaw tips 12/14 can be made of a hard plastic such as poly-vinyl or hard rubber. The engagement arms 13/15 are preferably made of metal to provide strength but in some embodiments are made from plastic. The engagement arms 13/15 are pivotally connected with a rivet 16 or other shaft and are spring biased by a spring (shown in FIG. 3), thereby forming a clamp that holds objects between the jaw tips 12/14. The engagement arm ends 20/22 allow force to be applied to open the clamp. Inward pressure applied to the engagement arm ends 20/22 counteracts the force of the spring, thereby opening a space between the jaw tips 12/14. Also shown in FIG. 1 is a fishhook 30, shown being held firmly in the fishhook holder 10. The fishhook 30 has an eye or eyelet 32 where a fishing line is to be attached and a barb end 34, shown passing through a hole 18 in the engagement arms 13/15. In some embodiments, a hook guard 26 partially covers the fishing hook 30 and its barb 34, reducing the risk of getting stuck with the barb 34.

Referring to FIG. 2, a plan view of a fishhook holder of the present invention without fishing hook is shown. The fishhook holder 10 is a spring-tensioned device having jaw tips 12/14 for grasping the fishhook 30. In one embodiment, the jaw tips 12/14 are a continuous part of the engagement arms 13/15. In another embodiment, the jaw tips 12/14 are formed separately of a different material than that of the engagement arms 13/15. For example, the engagement arms can be made of copper or steel while the jaw tips 12/14 can be made of a hard plastic or hard rubber. The engagement arms 13/15 are pivotally connected with a rivet 16 or other type of shaft and are spring biased by a spring (shown in FIG. 3), thereby forming a clamp that holds objects between the jaw tips 12/14. The engagement arm ends 20/22 allow force to be applied to open the clamp, counteracting the spring. Inward pressure is applied to the engagement arm ends 20/22 counteracts the force of the spring, thereby opening a space between the jaw tips 12/14. The holes 18 for accepting a fishhook (not shown in FIG. 2) are visible.

Referring to FIG. 3, a rear view of the fishhook holder present invention is shown. The backs of the engagement arm ends 20/22 are visible as well as the rivet 16 or other type of shaft. In this embodiment, the engagement arms are spring biased by a coil spring 28 that encircles the rivet 16. In other embodiments, other types of springs are used and work equally as well.

Referring to FIG. 4, a front perspective view of the fishhook holder of the present invention is shown. The fishhook holder 10 is a spring-tensioned device having jaw tips 12/14 for grasping the fishhook 30. In one embodiment, the jaw tips 12/14 are a continuous part of the engagement arms 13/15. In another embodiment, the jaw tips 12/14 are formed separately of a different material than that of the engagement arms 13/15. For example, the engagement arms can be made of copper or steel while the jaw tips 12/14 can be made of a hard plastic or hard rubber. The engagement arms 13/15 are pivotally connected with a rivet 16 or other shaft and are spring biased towards each other by a spring (shown in FIG. 3), thereby forming a clamp that holds objects between the jaw tips 12/14. The engagement arm ends 20/22 allow force to be applied to open the clamp. Inward pressure applied to the engagement arm ends 20/22 counteracts the force of the spring, thereby opening a space between the jaw tips 12/14. Also shown in FIG. 1 is a fishhook 30, shown being held firmly in the fishhook holder 10. The fishhook 30 has an eye 32 where a fishing line is to be attached and a barb 34 end, shown passing through a hole 18 in the engagement arms 13/15. In some embodiments, a hook guard 26 partially covers the fishing hook 30 and its barb 34, reducing the risk of getting stuck with the barb 34.

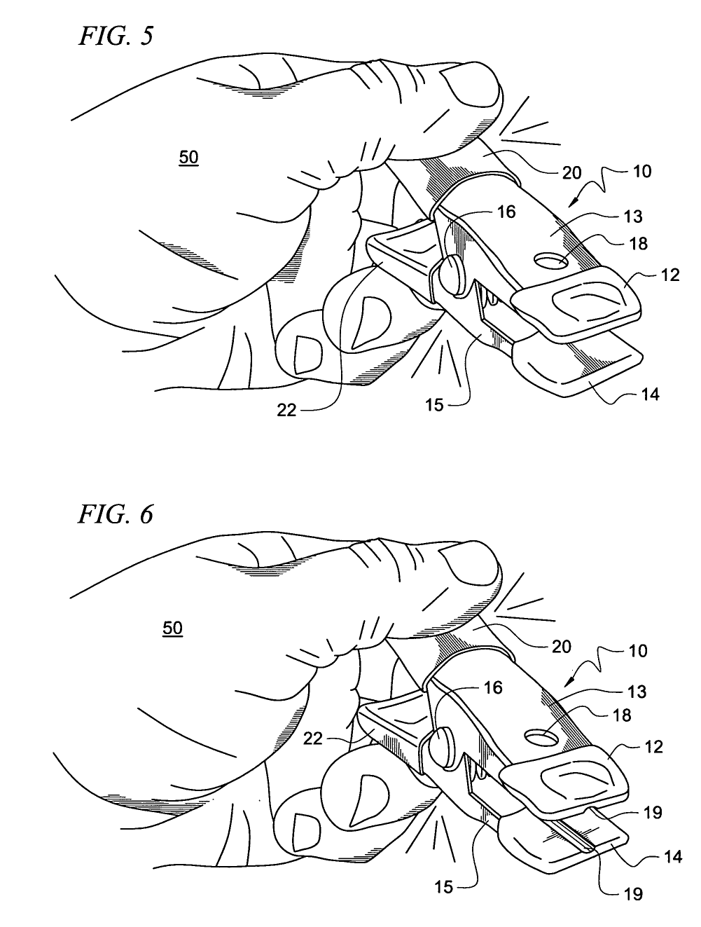

Referring to FIG. 5, a front perspective view of the fishhook holder of the present invention is shown. The fishhook holder 10 is a spring-tensioned device having jaw tips 12/14 for grasping the fishhook 30. In this embodiment, the jaw tips 12/14 are formed separately of a different material than that of the engagement arms 13/15. For example, the engagement arms can be made of copper or steel while the jaw tips 12/14 can be made of a hard plastic or hard rubber. The engagement arms 13/15 are pivotally connected with a rivet 16 or other shaft and are spring biased by a spring (shown in FIG. 3), thereby forming a clamp that holds objects between the jaw tips 12/14. The engagement arm ends 20/22 are shown being pressed by a hand 50 to hold open the fishhook holder 10. Inward pressure applied to the engagement arm ends 20/22 counteracts the force of the spring, thereby opening a space between the jaw tips 12/14. In this embodiment, the jaw tips 12/14 are relatively flat.

Referring to FIG. 6, a front perspective view of a second embodiment of the fishhook holder of the present invention is shown. The fishhook holder 10 is a spring-tensioned device having jaw tips 12/14 for grasping the fishhook 30. In this embodiment, the jaw tips 12/14 are formed separately of a different material than that of the engagement arms 13/15. For example, the engagement arms can be made of copper or steel while the jaw tips 12/14 can be made of a hard plastic or hard rubber. The engagement arms 13/15 are pivotally connected with a rivet 16 or other shaft and are spring biased by a spring (shown in FIG. 3), thereby forming a clamp that holds objects between the jaw tips 12/14. The engagement arm ends 20/22 are shown being pressed by a hand 50 to hold open the fishhook. holder 10. Inward pressure applied to the engagement arm ends 20/22 counteracts the force of the spring, thereby opening a space between the jaw tips 12/14. In this embodiment, grooves 19 are cut approximately in the center of the jaw tips 12/14. The grooves 19 are preferably slightly smaller in diameter than the intended fishhook, thereby providing a better grip on the fishhook and preventing it from moving angularly within the fishhook holder 10.

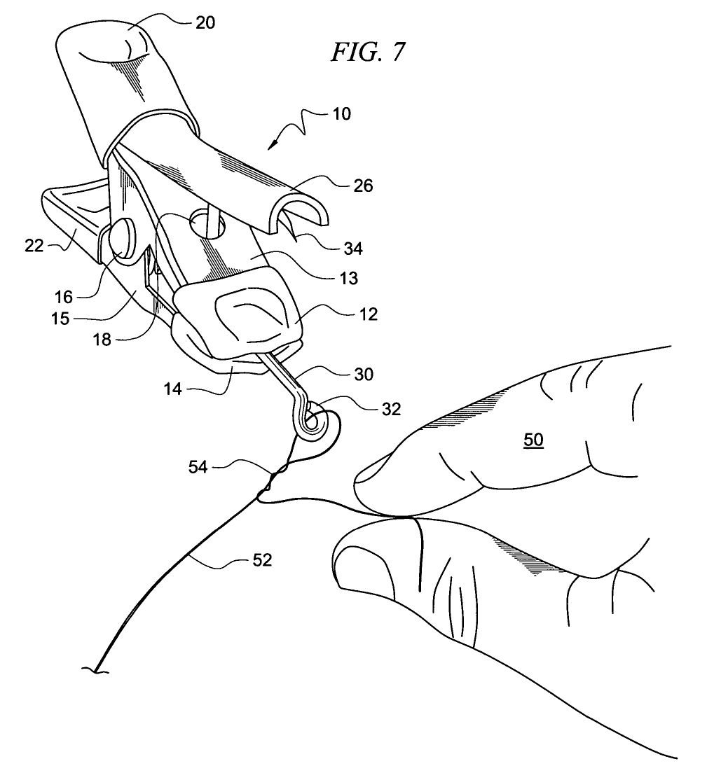

Referring to FIG. 7, a front perspective view of the fishhook holder of the present invention as it is being used is shown. As previously described, the fishhook holder 10 is a spring-tensioned device having jaw tips 12/14 for grasping the fishhook 30. The engagement arms 13/15 are pivotally connected with a rivet 16 or other shaft and are spring biased by a spring (shown in FIG. 3), thereby forming a clamp that holds objects between the jaw tips 12/14. The engagement arm ends 20/22 allow force to be applied to open the clamp. Inward pressure applied to the finger arms 20/22 counteracts the force of the spring, thereby opening a space between the jaw tips 12/14. Also shown in FIG. 1 is a fishhook 30, shown being held firmly in the fishhook holder 10. The fishhook 30 has an eye 32 where a fishing line 52 is being attached by a hand 50 which is making a knot 54 in the fishing line 52. The barb end 34 of the fishhook 30 passes through a hole 18 in the engagement arms 13/15. In some embodiments, a hook guard 26 partially covers the fishing hook 30 and its barb 34, reducing the risk of getting stuck with the barb 34.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A fishhook holder comprising:
a first engagement jaw and a second engagement jaw for engaging a fishhook there between;
a first engagement arm pivotally interfaced with a second engagement arm by a pivot, the first engagement jaw being at a front end of the first engagement arm and the second engagement jaw being at a front end of the second engagement arm, the first engagement arm extending beyond the pivot, thereby forming a first handle and the second engagement arm extending beyond the pivot, thereby forming a second handle;
a spring operatively coupled between and applying outward force against the first and second handle, thereby applying a closing force between the first engagement jaw and the second engagement jaw; and
a hole in the first engagement arm between the first engagement jaw and the pivot for accepting a barb of the fishhook.

2. The fishhook holder of claim 1, further comprising a hook guard affixed to the first engagement arm and adapted to at least partially cover the barb of the fishhook when the fishhook is held between the first engagement jaw and the second engagement jaw and the barb of the fishhook passes through the hole.

3. The fishhook holder of claim 1, wherein the first engagement jaw is an edge of the first engagement arm.

4. The fishhook holder of claim 1, wherein the second engagement jaw is an edge of the second engagement arm.

5. The fishhook holder of claim 1, wherein the first engagement jaw is affixed to the first engagement arm.

6. The fishhook holder of claim 1, wherein the second engagement jaw is affixed to the second engagement arm.

7. The fishhook holder of claim 1, further comprising a groove in the second engagement jaw.

8. The fishhook holder of claim 1, further comprising a groove in the first engagement jaw and a groove in the second engagement jaw.

9. A method of tying a fishing line to a fishhook, the method comprising:
providing a fishhook holder comprising:
a first engagement jaw and a second engagement jaw for engaging a fishhook there between;
a first engagement arm pivotally interfaced with a second engagement arm by a pivot, the first engagement jaw being at a front end of the first engagement arm and the second engagement jaw being at the front of the second engagement arm, the back end of the first engagement arm extending beyond the pivot, thereby forming a first handle and the back end of the second engagement arm extending beyond the pivot, thereby forming a second handle;
a spring operatively coupled between and applying outward force against the first and second handle, thereby applying a closing force between the first engagement jaw and the second engagement jaw;
a hole in the first engagement arm between the first engagement jaw and the pivot for accepting a barb end of the fishhook; and
a groove in an interfacing surface of the second engagement jaw for accepting the fishhook;
squeezing the first and second handle, thereby opening the first engagement jaw and the second engagement jaw;
inserting the barb end of the fishhook between the first engagement jaw and the second engagement jaw, passing through the hole in the first engagement arm and resting within the groove;
releasing the first and second handle, thereby holding the fishing hook tightly between the first engagement jaw and the second engagement jaw;
tying the fishing line to an eyelet of the fishing hook;
squeezing the first and second handle a second time, thereby opening the first engagement jaw and the second engagement jaw; and
removing the fishhook from the fishhook holder.

10. The method of claim 9, further comprising a second groove in the first jaw for accepting the fishhook.

11. The fishhook holder of claim 9, further comprising a hook guard adapted to the first engagement arm and adapted to at least partially cover the barb of the fishhook when the fishhook is held between the first engagement jaw and the second engagement jaw and the barb of the fishhook passes through the hole.

12. The fishhook holder of claim 9, wherein the first engagement jaw is an edge of the first engagement arm.

13. The fishhook holder of claim 9, wherein the second engagement jaw is an edge of the second engagement arm.

14. The fishhook holder of claim 9, wherein the first engagement jaw is affixed to the first engagement arm.

15. The fishhook holder of claim 9, wherein the second engagement jaw is affixed to the second engagement arm.

16. A fishhook holder comprising:
a first engagement arm having a first jaw and a first handle end;
a second engagement arm having a second jaw and a second handle end;
a pivot means movably coupling the first engagement arm with the second engagement arm;
a spring means interposed between the first handle end and the second handle end, the spring means exerting outward force between the first handle end and the second handle end thereby exerting a closing force between the first jaw and the second jaw;
a groove in an engagement surface of at least one of the first jaw and the second jaw for holding a fishhook in place between the first jaw and the second jaw;
a hook receiving hole in the first engagement arm positioned substantially centered widthwise and positioned between the first jaw and the pivot means; and
a guard means affixed to the first engagement arm, at least partially covering the hook receiving hole, and adapted to at least partially cover a barb end of the fishhook when the fishhook is held between the first jaw and the second jaw and the barb of the fishhook passes through the hook receiving hole.

17. The fishhook holder of claim 1, wherein the first jaw is an edge of the first engagement arm.

18. The fishhook holder of claim 1, wherein the second jaw is an edge of the second engagement arm.

19. The fishhook holder of claim 1, wherein the first jaw is affixed to the first engagement arm.

20. The fishhook holder of claim 1, wherein the second jaw is affixed to the second engagement arm.
